(19) United States
(12) Patent Application Publication
(10) Pub. No.: US 2015/0265862 A1
(43) Pub. Date: Sep. 24, 2015

(54) FIRE SUPPRESSION BLANKET

(71) Applicants: Hannu Reiman, Tuusula (FI); Sari Reiman, Tuusula (FI)

(72) Inventors: Hannu Reiman, Tuusula (FI); Sari Reiman, Tuusula (FI)

(21) Appl. No.: 14/222,883

(22) Filed: Mar. 24, 2014

(51) Int. Cl. A62C 8/06

(52) U.S. Cl. CPC A62C 8/06

(57) ABSTRACT

A fire suppression blanket, which is made of fire resistant material and has two side faces, four edges and two mutually crossing center lines, wherein close to one edge of the blanket there has been fixed at least two pockets having their mouth opening towards a centerline of the blanket and being made of fire resisting material.

The invention relates to a fire suppression blanket, which is made of fire resistant material and has two side faces, four edges and two mutually crossing center lines.

Household fire suppression blankets are commonly used to extinguish accidental cooking fires such as cooking oil fires. The blankets are equipped with hand holding devices which consist of straps sewn in the blanket to extend from the edge of the blanket outside the blanket surface area. These straps can be used to pull out the blanket from its packing container, but they don't give any protection for the hands when the blanket is spread and distributed over the fire.

The aim of the present invention is to provide such a fire suppression blanket, which can be easily spread and distributed over the fire while keeping the hands well protected.

This is achieved by the present invention wherein close to one edge of the blanket there has been fixed at least two pockets having their mouth opening towards a centerline of the blanket and being made of fire resisting material.

The invention is illustrated in the following by way of examples referring to the enclosed drawing wherein

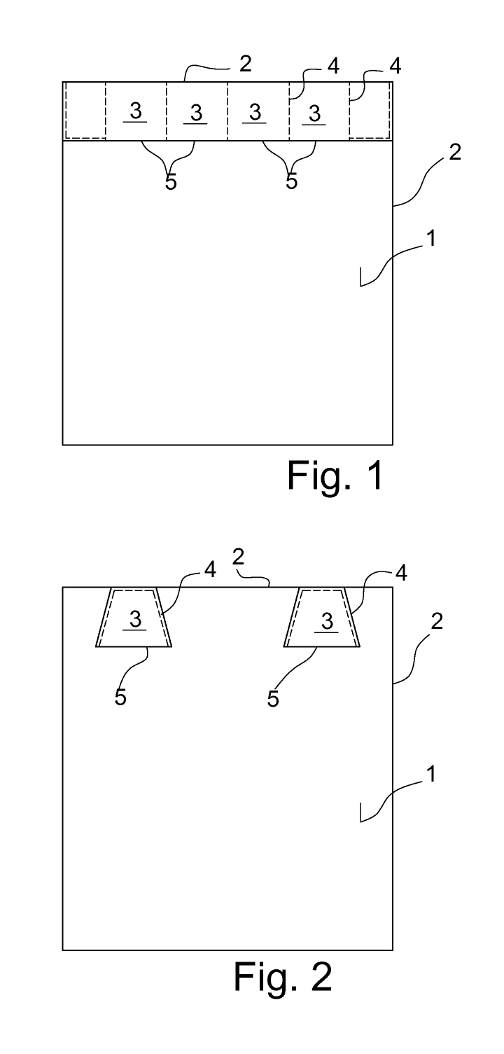

FIG. 1 shows one embodiment of a spread fire suppression blanket seen from above, and

FIG. 2 shows another embodiment of a spread fire suppression blanket seen from above.

In both embodiments the fire suppression blanket is made of fire resistant material such as glass fiber cloth or any other material as used in the fire suppression blankets. The blanket has two side faces 1, four edges 2 and two mutually crossing center lines. Close to one edge 2 of the blanket there has been fixed at least two pockets 3 having their mouth opening 5 towards a centerline of the blanket. The pockets are made of fire resisting material, for instance of the same material as the blanket.

In the embodiment of FIG. 1 the pockets 3 are integral parts of the blanket, which has been folded and sewed to form the pockets. The folding line forms one edge 2 of the blanket. Sewing stitches 4 close the side edges of the pockets. The deepness of the pockets is more than 10 cm preferably more than 15 cm, for instance about 20 cm. Also width of the pockets is more than 15 cm to avoid jamming of hands.

Preferably the pockets are symmetrically on both sides of the centerline of the blanket. In the embodiment of FIG. 1 there are at least four pockets 3 side by side.

In the embodiment of FIG. 2 the pockets 3 are widening towards their mouth openings. There are two pockets fixed by sewing stitches 4 to the blanket. In this case the pocket material may be thinner than the blanket to save space in the packing container. Nevertheless the pockets give good protection for the hands which may be exposed to fire for a short time.

If desired, there may be pockets 3 on both sides of the blanket either close to the same 2 edge or opposite edges. The relative term “close to” means in this connection a distance which does not exceed the deepness of the pocket.

The traditional hand straps (not shown) can be attached at any edge of the blanket, preferably at the same edge with the pockets.

1. A fire suppression blanket, which is made of fire resistant material and has two side faces, four edges and two mutually crossing center lines, wherein close to one edge of the blanket there has been fixed at least two pockets having their mouth opening towards a centerline of the blanket and being made of fire resisting material.

2. Fire suppression blanket according to claim 1, wherein the pockets are made of the same material as the blanket.

3. Fire suppression blanket according to claim 1, wherein the pockets are integral parts of the blanket, which has been folded and sewed to form the pockets.

4. Fire suppression blanket according to claim 1, wherein the deepness of the pockets is more than 10 cm.

5. Fire suppression blanket according to claim 1, wherein the deepness of the pockets is more than 15 cm.

6. Fire suppression blanket according to claim 1, wherein the pockets are widening towards their mouth openings.

7. Fire suppression blanket according to claim 1, wherein there are pockets on both sides of the blanket.

8. Fire suppression blanket to claim 1, wherein the pockets art symmetrically on both sides of a centerline of the blanket.

9. Fire suppression blanket according to claim 3, wherein there are at least four pockets side by side.

10. Fire suppression blanket according to claim 2, wherein the pockets are integral parts of the blanket, which has been folded and sewed to form the pockets.
